(19) United States
(12) Patent Application Publication
(10) Pub. No.: US 2025/0153694 A1
(43) Pub. Date: May 15, 2025

(54) DRIVING ASSISTANCE DEVICE AND METHOD FOR CHILD PROTECTION ZONE

(71) Applicant: HL KLEMOVE CORP., Incheon (KR)

(72) Inventor: Cheolweon JANG, Incheon (KR)

(21) Appl. No.: 18/744,488

(22) Filed: Jun. 14, 2024

(30) Foreign Application Priority Data
Nov. 15, 2023 (KR) 10-2023-0158102

(51) Int. Cl. B60T 8/58; B60K 35/22; B60K 35/23; B60K 35/26; B60K 35/28; B60T 7/22; B60T 8/171; G06T 3/60; G06T 7/50; G06T 7/70; G06V 10/764; G06V 20/52; G06V 40/10; G08G 1/09; G08G 1/0962

(52) U.S. Cl. CPC B60T 8/58; B60K 35/22; B60K 35/23; B60K 35/26; B60K 35/28; B60T 7/22; B60T 8/171; G06T 3/60; G06T 7/50; G06T 7/70; G06V 10/764; G06V 20/52; G06V 40/10; G08G 1/093; G08G 1/0962; B60K 2360/178; B60K 2360/179; B60K 2360/589; B60T 2201/022; B60T 2210/32; B60T 2250/04; G06T 2207/30196; G06T 2207/30232; G06V 2201/10

(57) ABSTRACT

A child protection zone driving assistance device includes a transceiver configured to receive image data received from a surveillance camera having a constant sensing field of view within a child protection zone from a communication device and a processor configured to recognize a pedestrian based on the image data, determine location information about the pedestrian as either left or right based on a driving direction when the pedestrian is recognized, and control a display device of a vehicle to display the determined location information, and may display a location of the pedestrian present in a blind spot in the child protection zone as left or right based on the driving direction of the vehicle together with a warning, thereby encouraging safe driving and improving driving convenience.

### CROSS-REFERENCE TO RELATED APPLICATION

This application claims the priority to and benefit of Korean Patent Application No. 10-2023-0158102, filed on Nov. 15, 2023 in the Korean Intellectual Property Office, the disclosure of which is incorporated herein by reference in its entirety.

### BACKGROUND

### 1. Field

Embodiments of the present disclosure relate to a driving assistance device and a driving assistance method for a child protection zone.

### 2. Description of the Related Art

In 2020, the first year of enforcement of the Aggravated Punishment of Specific Crimes, known as the Minsik Act, traffic accidents involving children by vehicles traveling exceeding 30 km/h in child protection zones have significantly decreased, but 88% of traffic accidents in child protection zones still occur at speeds of 30 km/h or less.

That is, despite drivers' efforts to follow the laws, the possibility of accidents is still high due to careless driving or blind spots caused by illegally parked vehicles. Due to the uncertainties, some drivers drive slowly even when there are no pedestrians around, and sometimes the situation hinders traffic efficiency.

However, up to date, there is no technology that allows a vehicle traveling in a child protection zone to easily find out whether there are pedestrians in the blind spot around the vehicle.

### SUMMARY

Therefore, it is an aspect of the present disclosure to provide a driving assistance device and a driving assistance method for a child protection zone, capable of displaying location information about a pedestrian present in a blind spot on a vehicle using a surveillance camera and vehicle-to-everything (V2X) communication in the child protection zone.

In accordance with one aspect of the present disclosure, a driving assistance device includes a transceiver configured to receive image data received from a surveillance camera having a constant sensing field of view within a child protection zone from a communication device and a processor configured to recognize a pedestrian based on the image data, determine location information about the pedestrian as either left or right based on a driving direction when the pedestrian is recognized, and control a display device of a vehicle to display the determined location information.

The processor may determine the location information about the pedestrian based on metadata of the image data and driving information about the vehicle.

The processor may be configured to horizontally flip an image acquired from the image data, determine the location information about the pedestrian as left when the location of the pedestrian is on the left based on an exact center of the horizontally flipped image, and determine the location information about the pedestrian as right when the location of the pedestrian is on the right and confirm the location information about the pedestrian when a reference direction of the image data matches the driving direction.

The processor may horizontally flip the location information about the pedestrian when a reference direction of the image data is opposite to the driving direction, and control the display device to display the horizontally flipped location information about the pedestrian.

The location information about the pedestrian may further include a distance between the vehicle and the pedestrian.

The processor may determine a possibility of collision based on the distance between the vehicle and the pedestrian or a driving speed of the vehicle, and control one of a driving device, a braking device, or a steering device of the vehicle based on the determination result.

The processor may control the display device to display a collision risk warning when the possibility of collision is equal to or higher than a first risk level and less than a second risk level.

The processor may control the braking device to perform emergency braking when the possibility of collision is equal to or higher than the second risk level.

The processor may control an audio device of the vehicle to represent the location information about the pedestrian as an auditory signal.

The processor may classify the type of the pedestrian and control the display device to further display information on the type of the pedestrian.

The processor may control an audio device of the vehicle to represent the information on the type of the pedestrian as an auditory signal.

The image data may be received from the surveillance camera by a communication device configured to perform vehicle-to-everything (V2X) communication.

The display device may be one of a cluster display, a center fascia display, or a head-up display (HUD).

In accordance with another aspect of the present disclosure, a driving assistance method performed by a driving assistance device based on image data received through V2X communication with a surveillance camera having a constant sensing field of view in a child protection zone includes determining whether a vehicle has entered a child protection zone, receiving image data from the surveillance camera having the constant sensing field of view in the child protection zone when it is determined that the vehicle has entered the child protection zone, recognizing a pedestrian based on the image data, determining location information about the pedestrian as either left or right based on a driving direction when the pedestrian is recognized, and displaying the determined location information about the pedestrian on a display device of the vehicle.

In the determining of the location information about the pedestrian, an image acquired from the image data may be horizontally flipped, the location information about the pedestrian may be determined as left when the location of the pedestrian is on the left based on an exact center of the horizontally flipped image, the location information about the pedestrian may be determined as right when the location of the pedestrian is on the right, and the location information about the pedestrian is confirmed when a reference direction of the image data matches the driving direction.

In the determining of the location information about the pedestrian, the location information about the pedestrian may be horizontally flipped when a reference direction of the image data is opposite to the driving direction, and the display device may be controlled to display the horizontally flipped location information about the pedestrian.

The driving assistance method may further include, after the determining of the location information about the pedestrian, determining a possibility of collision based on a distance between the vehicle and the pedestrian and a driving speed of the vehicle and controlling one of a driving device, a braking device, or a steering device of the vehicle based on the determination result.

In the controlling of one of the driving device, the braking device, or the steering device of the vehicle based on the determination result, the display device may be controlled to display a collision risk warning when the possibility of collision is equal to or higher than a first risk level and less than a second risk level.

In the controlling of one of the driving device, the braking device, or the steering device of the vehicle based on the determination result, the braking device may be controlled to perform emergency braking when the possibility of collision is equal to or higher than the second risk level.

In accordance with still another aspect of the present disclosure, a child protection zone blind spot warning system includes a detection system configured to recognize a pedestrian based on image data acquired through a surveillance camera that is installed in a child protection zone and has a constant sensing field of view, and acquire location information about the pedestrian based on the image data and the pedestrian and transmit the location information to a traveling vehicle travelling in the child protection zone and a driving assistance device configured to display the location information about the pedestrian to a driver, in which the location information about the pedestrian indicates either left or right based on a driving direction of the vehicle, and the detection system and the driving assistance device perform V2X communication.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 illustrates a child protection zone blind spot warning system according to one embodiment;

FIG. 2 illustrates a configuration of a detection system according to one embodiment;

FIG. 3 illustrates a configuration of a vehicle according to one embodiment;

FIG. 4 is a view illustrating a situation where pedestrians are present in a child protection zone blind spot;

FIG. 5 illustrates a situation in which location information about a pedestrian is displayed on a head-up display of a vehicle in a child protection zone blind spot warning system according to one embodiment;

FIG. 6 is a flowchart showing a driving assistance method according to one embodiment; and

FIG. 7 is a flowchart showing a driving assistance method according to another embodiment.

### DETAILED DESCRIPTION

Like reference numerals refer to like elements throughout the specification. Not all elements of embodiments will be described in the specification, and general information in the technical field to which the present disclosure pertains or overlapping information between the embodiments will be omitted. The terms “part,” “module,” “member,” or “block” as used throughout the specification may be implemented in software or hardware, and a plurality of “parts,” “modules,” “members,” or “blocks” may be implemented in a single component, or a single “part,” “module,” “member,” or “block” may include a plurality of components.

It will be understood that when a component is referred to as being “connected” to another component throughout the specification, it can be directly or indirectly connected to the other component. When a component is indirectly connected to another component, it may be connected to the other component through a wireless communication network.

In addition, when a part “includes” or “comprises” a component, unless described to the contrary, the term “includes” or “comprises” does not indicate that the part excludes another component but instead indicates that the part may further include the other component.

Terms such as first, second, etc., are used to distinguish one component from another component, and the components are not limited by the above-described terms.

Unless the context clearly indicates otherwise, the singular forms include the plural forms.

In each operation, identification codes are used for convenience of description but are not intended to illustrate the order of the operations, and each operation may be implemented in an order different from the illustrated order unless explicitly stated in the context.

Hereinafter, a working principle and embodiments of the present disclosure will be described with reference to the accompanying drawings.

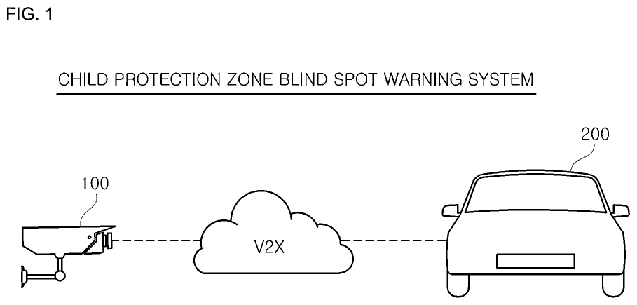

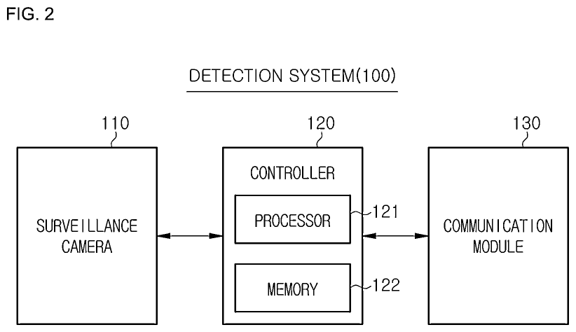

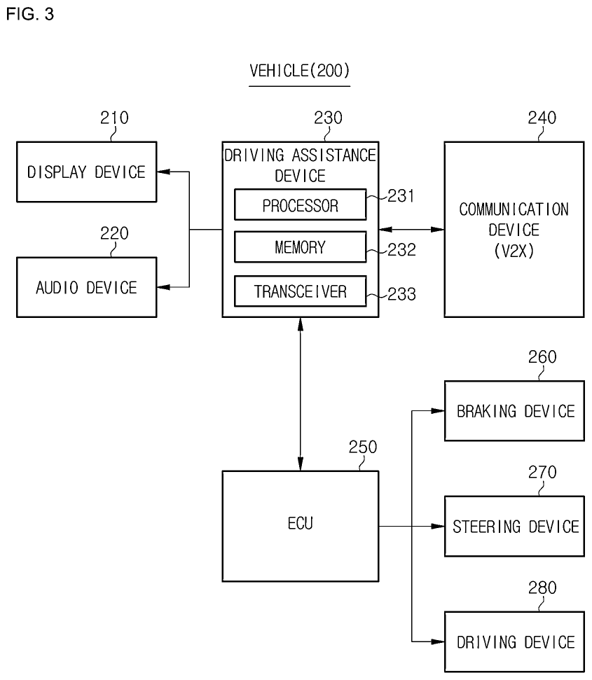

FIG. 1 illustrates a child protection zone blind spot warning system 1 according to one embodiment, FIG. 2 illustrates a configuration of a detection system 100 according to one embodiment, and FIG. 3 illustrates a configuration of a vehicle 200 according to one embodiment.

Referring to FIG. 1, the child protection zone blind spot warning system 1 according to one embodiment of the present disclosure may be implemented in the form of the detection system 100 and the vehicle 200.

Here, a “pedestrian” refers to a pedestrian who is moving in a child protection zone and is recognized or identified by the child protection zone blind spot warning system 1. That is, a person who is moving in the child protection zone, but is not recognized or identified by the child protection zone blind spot warning system 1 does not refer to a pedestrian in the present disclosure.

As described above, in the child protection zone blind spot warning system 1 according to the embodiment of the present disclosure, the pedestrian and the vehicle 200 have to not only be moving and traveling in the child protection zone, but also be recognized by the child protection zone blind spot warning system 1.

Since presence of a person who is not recognized by the child protection zone blind spot warning system 1 is unknown, any information may not be provided to a driver. In addition, since presence of a vehicle that is not recognized by the child protection zone blind spot warning system 1 is unknown, information related to a pedestrian, such as location information about the pedestrian, may not be provided.

According to one embodiment, the detection system 100 may transmit image data acquired through a surveillance camera 110 installed in the child protection zone and having a constant sensing field of view 110a to the vehicle 200. In this case, the detection system 100 may only perform the role of transmitting image data to the vehicle 200. That is, the detection system 100 may be limited to acquiring image data for the sensing field of view 110a and transmitting the image data to the vehicle 200 without recognizing the pedestrian or acquiring the location information about the pedestrian.

According to one embodiment, the detection system 100 may recognize a pedestrian based on image data acquired through the surveillance camera 110 that is installed in the child protection zone and has the constant sensing field of view 110a, and acquire location information about the pedestrian based on the image data and the recognized pedestrian and transmit the location information to the vehicle 200 traveling in the child protection zone.

The vehicle 200 may display the location information about the pedestrian to the driver.

To this end, the detection system 100 and the vehicle 200 may exchange information through vehicle-to-everything (V2X) communication.

V2X communication refers to a technology that allows two-way information exchange between the vehicle and surrounding infrastructure. For example, V2X may collectively refer to wireless communication between vehicles (vehicle to vehicle: V2V), wireless communication between a vehicle and infrastructure (vehicle to infrastructure: V2I), wired and wireless in-vehicle networking (in-vehicle Networking: IVN), communication between a vehicle and a mobile device (vehicle to pedestrian: V2P), and the like.

The detection system 100 may include the surveillance camera 110, a controller 120, and a communication module 130.

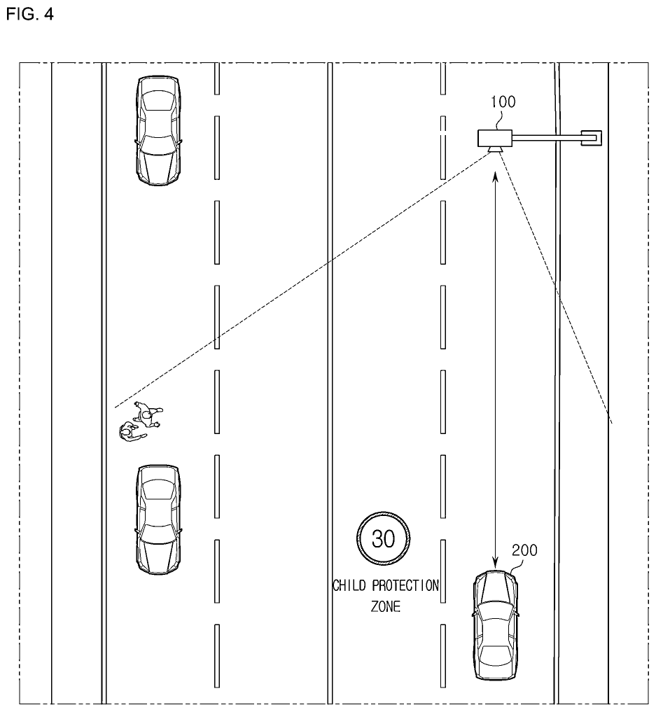

The surveillance camera 110 may be installed in the child protection zone and have the constant sensing field of view 110a. The surveillance camera 110 may photograph detection target lanes and acquire image data of the sensing field of view 110a. For example, as illustrated in FIG. 4, the surveillance camera 110 may be disposed to be fixed to one end of a support (not illustrated) installed to extend over the detection target lanes on one sidewalk.

The surveillance camera 110 may include a plurality of lenses and an image sensor. The image sensor may include a plurality of photodiodes that convert light into electrical signals, and the plurality of photodiodes may be arranged in a two-dimensional matrix.

The surveillance camera 110 may have fields of view in opposite directions, that is, one field of view facing a vehicle approaching the surveillance camera 110, and the other field of view facing a 180-degree opposite direction. In this case, the surveillance camera 110 may include a first camera for monitoring the approaching vehicle 200 in the detection target lanes and a second camera facing the vehicle 200 moving away from the surveillance camera 110. In this case, a reference direction of the first camera and a reference direction of the second camera are opposite directions based on a first image acquired through image data of the first camera and a second image acquired through image data of the second camera.

According to one embodiment, when the surveillance camera 110 includes the first camera and the second camera each having a field of view in opposite directions, the controller 120 may horizontally flip an image of the first camera to determine location information about the pedestrian based on the horizontally flipped image, but may not horizontally flip an image of the second camera to determine the location information about the pedestrian based on the original image.

In this way, when the surveillance camera 110 includes two cameras (the first camera and the second camera) each having a field of view in opposite directions, the surveillance camera 110 may have twice the sensing field of view compared to a surveillance camera including a single camera having a general sensing field of view, so that a wider blind spot may be handled and thus the effect of encouraging safe driving of the vehicle and preventing accidents may be greatly improved.

According to one embodiment, the surveillance camera 110 may be a camera having a 360-degree sensing field of view.

The image data may include information on the vehicle 200, the pedestrian, a cyclist, or a lane line (a marker distinguishing lanes).

The surveillance camera 110 may include an image processor (not illustrated) for acquiring image data from the image sensor of the camera and detecting and identifying objects present around detection target lanes based on processing of the image data. For example, the image processor may identify the vehicle 200, the pedestrian, the cyclist, the lane line, or the like on an image plane using image processing.

Alternatively, the image processor may only perform the role of acquiring image data from the image sensor of the camera and generating an image through the acquiring, like a typical camera. Operations such as detecting, identifying, and classifying objects from the image acquired from image data may be performed by the processor 121 of the controller 120 or a processor 231 of a driving assistance device 230, which will be described below.

The controller 120 may be installed inside the support and connected to the surveillance camera 110 and the communication module 130, and may control the surveillance camera 110 and the communication module 130.

To this end, the controller 120 may include the processor 121 and a memory 122.

The processor 121 may perform operations such as recognizing a pedestrian, determining location information about the pedestrian, determining whether the vehicle 200 is a forward vehicle 200, transmitting the location information about the pedestrian, and transmitting information on the type of the pedestrian.

The processor 121 may recognize a pedestrian from the image and classify the types of the pedestrian.

The processor 121 may detect and identify objects present around detection target lanes by performing processing on the image. For example, the processor 121 may identify the vehicle 200, the pedestrian, the cyclist, the lane, or the like on the image plane.

The processor 121 may determine the location information about the pedestrian. Looking at this in more detail, the processor 121 horizontally flips the image acquired from image data captured by the surveillance camera 110 (in the case where the surveillance camera 110 is made up of a general single camera). Next, the processor 121 determines the location information about the pedestrian as left when the location of the pedestrian is on the left based on an exact center of the horizontally flipped image, and determines the location information about the pedestrian as right when the location of the pedestrian is on the right.

The memory 122 may store various data, programs, and information, such as a preset reference direction, an image processing algorithm for determining the location information about the pedestrian, an algorithm for determining whether the vehicle 200 is a forward vehicle 200, and storage of driving information received from the vehicle 200, to assist the operation of the processor 121.

Here, the preset reference direction generally refers to a direction opposite to a direction in which the surveillance camera 110 is facing. This will be described as follows. The surveillance camera 110 generally monitors a specific one-way lane among two-way lanes. In addition, in the specific one-way lane, the surveillance camera 110 has the sensing field of view 110a facing in a direction opposite to a direction of travel of the lane in which the surveillance camera 110 is located. Therefore, when a vehicle traveling in the relevant lane approaches the surveillance camera 110 and reaches an appropriate location, the surveillance camera 110 collects the speed of the vehicle and vehicle identification information.

For example, when the surveillance camera 110 is located on an upward lane heading from south to north, a direction in which the surveillance camera 110 faces is south, and an actual traveling direction of the upward lane is north. Accordingly, the preset reference direction is north.

Therefore, the image processing algorithm for determining the location information about the pedestrian stored in the memory 122 includes horizontally flipping the image generated by the surveillance camera 110.

The memory 122 may also store the algorithm for determining whether the vehicle 200 is a forward vehicle 200. For example, the algorithm for determining whether the vehicle 200 is a forward vehicle 200 includes determining whether a driving direction of the vehicle 200 matches a preset reference direction. When the driving direction and the reference direction match, the algorithm may include determining that the vehicle is the forward vehicle 200. In this case, the processor 121 transmits the location information about the pedestrian to the vehicle 200 without any additional processing. If the driving direction and the reference direction do not match, the algorithm may include determining that the vehicle is a reverse vehicle 200. In this case, the processor 121 may additionally include horizontally flipping the location information about the pedestrian in the algorithm. Accordingly, the processor 121 horizontally flips the location information about the pedestrian and transmits horizontally flipped location information about the pedestrian to the vehicle 200.

The communication module 130 includes V2X functions. To this end, the communication module 130 may support dedicated short-range communications (DSRC) and cellular V2X (C-V2X).

Here, DSRC is an ultra-short-range communication technology that provides fast latency and high reliability, and is mainly used in traffic safety applications.

C-V2X is a V2X communication technology based on LTE and 5G cellular networks and provides wider range and better communication performance.

In this way, the communication module 130 may be equipped with at least one of DSRC or C-V2X technology to support V2X functions. To this end, the communication module 130 may be a communication module 130 in which a communication chipset and an antenna supporting V2X are integrated.

In addition, the communication module 130 may support the IEEE 802.11p protocol for DSRC communication, the LET-V protocol for C-V2X communication, basic safety message (BSM) protocol of a message format that transmits basic information such as a state, speed, and direction of a vehicle, standard SAE J2735 protocol of V2X message set that defines various message formats and exchange patterns, or the like.

In addition, in the communication module 130, a contention-based forwarding (CBF) algorithm for determining which vehicle to transmit data packets to support V2X communication and an adaptive traffic beacon (ATB) algorithm for adjusting a message transmission speed according to traffic conditions may be integrated.

The vehicle 200 may include a display device 210, an audio device 220, a driving assistance device 230, a communication device 240, an electronic control unit (ECU) 250, a braking device 260, a steering device 270, and a driving device 280. In addition, although not illustrated, the vehicle 200 may include a driver assistance device and/or an autonomous driving device (not illustrated). Further, the vehicle 200 may further include sensors (not illustrated) for detecting dynamics of the vehicle. For example, the vehicle 200 may further include a vehicle speed sensor for detecting a longitudinal speed of the vehicle, an acceleration sensor for detecting a longitudinal acceleration and a lateral acceleration of the vehicle 200, and/or a gyro sensor for detecting a yaw rate, a roll rate, and a pitch rate of the vehicle.

The display device 210 may include a center fascia display, a cluster display, a head-up display, and the like, and may provide various information and entertainment to the driver through images and sounds. For example, the display device 210 may provide driving information about the vehicle, a warning message, or the like, to the driver.

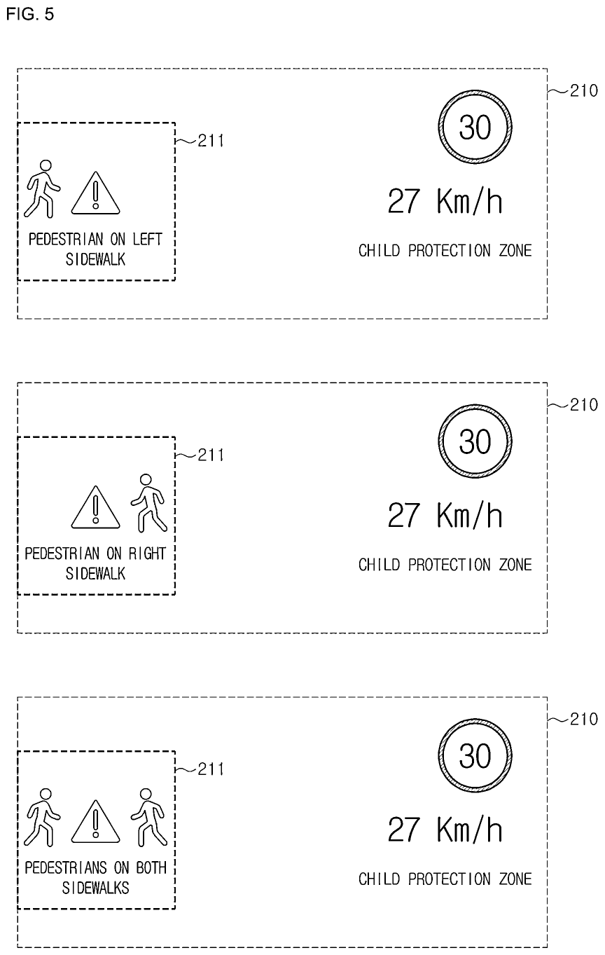

According to one embodiment, the display device 210 may be a head-up display (HUD) 210 as illustrated in FIG. 5. In recent years, the demand for the head-up display 210 has increased and is being employed in more vehicles. The head-up display 210 may assist safe driving by naturally providing useful information related to driving without interfering with the driver's driving.

On one side of the head-up display 210, a pedestrian warning region 211 may be displayed in a form of sliding in from an end of the display in an animated manner. Alternatively, the pedestrian warning region 211 may be displayed in a pop-up form on one side of the head-up display 210. A warning icon indicating caution may be displayed at the exact center of the pedestrian warning region 211. As the head-up display 210 receives the location information about the pedestrian from the processor 231, the head-up display 210 intuitively displays the recognized pedestrian as being present on the left or right based on the driving direction of the vehicle 200, thereby effectively raising the driver's alertness.

The audio device 220 may include a plurality of speakers and provide various information and entertainment to the driver through sounds. For example, the audio device 220 may provide driving information about the vehicle, a warning message, or the like, to the driver.

As the audio device 220 receives information about the pedestrian from the processor 231, the audio device 220 may notify the driver that the recognized pedestrian is on the left or right side of the vehicle 200 through an audio signal. To this end, the audio device 220 may be equipped with a text to speech (TTS) function.

The driving assistance device 230 may be connected to the display device 210, the audio device 220, the communication device 240, the electronic control unit 250, the braking device 260, the steering device, 270, the driving device 280, a navigation device, and/or a plurality of sensors through a vehicle communication network (NT) to transmit various control signals.

The driving assistance device 230 may recognize a pedestrian based on image data received from the surveillance camera 110 having a constant sensing field of view 110a within the child protection zone, determine location information about the pedestrian as either left or right based on a driving direction when the pedestrian is recognized, and control the display device 210 of the vehicle to display the determined location information.

To this end, the driving assistance device 230 may include the processor 231, the memory 232, and a transceiver 233.

The processor 231 may receive the image data received by the communication device 240 through the transceiver 233.

The processor 231 may recognize the pedestrian based on the image data, determine location information about the pedestrian as either left or right based on the driving direction when the pedestrian is recognized, and control the display device of the vehicle to display the determined location information.

The processor 231 may determine the location information about the pedestrian based on metadata of the image data and driving information about the vehicle.

Metadata (exchangeable image file format (EXIF)) is created when a photo is taken with a camera or smartphone, and is embedded in an image file and contains information about shooting conditions, camera settings, and the like. Examples of pieces of information that may be included in the metadata include a camera manufacturer and model, a shooting date and time, an exposure time, an aperture value, an ISO speed, a focal length, flash usage status, GPS information (location information), orientation, GPSImgDirection, and many other types of information. Among them, GPSImgDirection is used to indicate the direction of a camera lens.

The driving information about the vehicle may include various information such as the location, speed, direction, brake state, fuel level, and engine state, and the like of the vehicle.

The processor 231 horizontally flips the image acquired from the image data, determines the location information about the pedestrian as left when the location of the pedestrian is on the left based on the exact center of the horizontally flipped image, and determines the location information about the pedestrian as right when the location of the pedestrian is on the right.

In this case, the processor 231 may confirm the location information about the pedestrian when a reference direction of the image data matches the driving direction. To this end, the processor 231 may check a direction in which the surveillance camera 110 is facing based on GPSImgDirection in the metadata of the image data. The reference direction of the image data is exactly opposite to the direction in which the surveillance camera 110 is facing. For example, when the surveillance camera 110 is facing south, GPSImgDirection may indicate south among pieces of information included in the metadata in the image data of the surveillance camera 110. In this case, the reference direction of the image data is a 180 degrees inverted direction of GPSImgDirection, that is, north, which is the exact opposite of south. In this way, the processor 231 may compare the reference direction checked based on the metadata of the image data with the driving direction checked based on the driving information about the vehicle 200.

The processor 231 may horizontally flip the location information about the pedestrian if the reference direction of the image data is opposite to the driving direction and control the display device 210 to display the horizontally flipped location information about the pedestrian.

According to one embodiment, the processor 231 may estimate a distance between the vehicle 200 and the pedestrian based on driving information and image data of the vehicle 200. For example, the processor 231 may estimate an actual location of the pedestrian based on location information about the surveillance camera 110 based on the metadata of the image data and the location of the pedestrian recognized in the image data. Based on the estimated location of the pedestrian and the location information about the vehicle included in the driving information about the vehicle 200, the processor 231 may estimate the distance between the vehicle 200 and the pedestrian. The processor 231 may allow the location information about the pedestrian to further include the distance between the vehicle 200 and the pedestrian.

In addition, the processor 231 may determine a possibility of collision based on the distance between the vehicle 200 and the pedestrian and the driving speed of the vehicle 200 and control one of the braking device 260, the steering device 270, or the driving device 280 of the vehicle 200 based on the determination result.

More specifically, the processor 231 may control the display device 210 to display a collision risk warning when the possibility of collision is equal to or higher than a first risk level and less than a second risk level. The processor 231 may control the braking device 260 to perform emergency braking when the possibility of collision is equal to or higher than the preset second risk level. An indicator such as time-to-collision (TTC) may be used as a basis indicator for determining the possibility of collision.

The time-to-collision refers to a time remaining until the vehicle collides with another object when the vehicle maintains its current speed and direction. The time-to-collision is usually expressed in seconds, and when this value falls below a certain threshold, brakes or driving assistance technology may be activated to prevent a collision or cushion an impact.

In this case, the first risk level may refer to a case when an expected time-to-collision (TTC) has a predetermined threshold such as 10 seconds or 7 seconds. The second risk level may refer to a case when the expected time-to-collision (TTC) has a predetermined threshold such as 5 seconds or 3 seconds.

For example, the memory 232 included in the driving assistance device 230 may store the expected time-to-collision (TTC) within 10 seconds as the first risk level, and the expected time-to-collision within 5 seconds as the second risk level.

The processor 231 may estimate the expected time-to-collision (TTC) based on the distance between the vehicle 200 and the pedestrian and the driving speed of the vehicle 200 and compare with the estimated time-to-collision (TTC) with the threshold of the first risk level of 10 seconds and the threshold of the second risk level of 5 seconds, which are stored in the memory 232, when the estimated time-to-collision (TTC) is 8 seconds. In this case, the processor 231 may determine the possibility of collision as the first risk level based on the expected time-to-collision (TTC). Accordingly, the processor 231 may control the display device 210 to display the collision risk warning.

If the estimated expected time-to-collision (TTC) is 4 seconds, the processor 231 may determine the possibility of collision as the second risk level because the estimated expected time-to-collision (TTC) is less than 5 seconds, which is the threshold of the second risk level stored in the memory 232. Accordingly, the processor 231 may control the display device 210 to display the collision risk warning and simultaneously control the braking device 260 to perform emergency braking. More specifically, the processor 231 may transmit a control signal for emergency braking to the electronic control unit (ECU) 250, thereby allowing the electronic control unit 250 to perform control for emergency braking on the braking device 260. Alternatively, the processor 231 may directly control the braking device 260 by directly transmitting a control signal for emergency braking to the braking device 260. However, the present disclosure is not limited thereto, and when the possibility of collision is equal to or higher than the second risk level, the processor 231 may control one of the braking device 260, the steering device 270, or the driving device 280, or at least a combination of two devices thereof. For example, in a very urgent situation where the expected time-to-collision (TTC) is 1 or 2 seconds, the processor 231 may control the braking device 260 to perform emergency braking, and at the same time, perform steering control so that the steering device 270 changes the driving direction of the vehicle 200.

Meanwhile, the processor 231 may control the audio device 220 of the vehicle 200 to represent the location information about the pedestrian as an auditory signal. For example, the processor 231 may control the audio device 220 to convert the location information about the pedestrian into voice through text to speech (TTS) and provide the voice to the driver. Alternatively, the processor 231 may control the audio device 220 to sound an alarm. For example, when the possibility of collision is equal to or higher than the first risk level and less than the second risk level, the processor 231 may control the audio device 220, in addition to the display device 210, to convert the location information about the pedestrian into voice through text to speech (TTS) and provide the voice to the driver or sound an alarm. When the possibility of collision is equal to or higher than the second risk level, the processor 231 may control the audio device 220 to sound a louder alarm than the existing alarm.

The processor 231 may control a broadcast cycle of the communication device 240 to broadcast the driving information about the vehicle 200. In addition, the processor 231 may control the display device 210 and/or the audio device 220, thereby displaying the location information about the pedestrian and/or the information on the type of the pedestrian to the driver. The information on the type of the pedestrian may indicate one of a walking pedestrian, a running pedestrian, a kickboard user, or a cyclist.

According to one embodiment, the processor 231 may provide another vehicle 200 with the location information about the pedestrian used to provide a warning to the driver through the display device 210 and/or the audio device 220. For example, when the vehicle 200 is out of the V2X communication range of the detection system 100 but is driving within a child protection zone, the vehicle 200 may provide the location information about the pedestrian in advance to another vehicle 200 approaching from the opposite lane.

The memory 232 may store various data, programs and information to assist the operation of the processor 231. For example, the memory 232 may store unique vehicle identification information included in the driving information about the vehicle 200, and may temporarily store the location, driving direction, and driving speed of the vehicle 200.

The memory 232 may store the location information about the pedestrian and/or the information on the type of the pedestrian from the processor 231 or the detection system 100. The information on the type of the pedestrian may indicate one of a walking pedestrian, a running pedestrian, a kickboard user, or a cyclist.

Besides, the memory 232 may exchange data with the processor 231 and the display device 210, the audio device 220, the communication device 240, the braking device 260, the steering device 270, the driving device 280, the navigation device, and/or a plurality of sensors, or store settings values, status information, and the like for each device.

The transceiver 233 may exchange information with other parts or devices inside the vehicle 200 through the vehicle network communication NT. Examples of the vehicle network communication NT that the transceiver 233 may apply include Controller Area Network (CAN), Local Interconnect Network (LIN), Media Oriented Systems Transport (MOST), FlexRay, automotive Ethernet, and the like.

The memory 122 included in the detection system 100 and the memory 232 included in the driving assistance device 230 may include not only volatile memories such as a static random-access memory (S-RAM) and a dynamic random-access memory (D-RAM), but also non-volatile memories such as a flash memory, a read only memory (ROM), and an erasable programmable read only memory (EPROM).

The communication module 130 includes V2X functions. To this end, various technologies such as DSRC, C-V2X, or the like included in the detection system 100 may be installed, and accordingly, a communication chipset and antenna for V2X support may be provided. Besides, the communication device 240 may include various protocols and algorithms for V2X communication.

When the vehicle enters a child protection zone, the communication device 240 may periodically broadcast the driving information under the control of the processor 231. The driving information may include unique identification information, location, driving direction, and driving speed of the vehicle 200. In this case, the driving information may be generated in the message format of the BSM protocol.

The communication device 240 may receive image data or location information about the pedestrian and/or information on the type of the pedestrian from the detection system 100.

According to one embodiment, the child protection zone blind spot warning system 1 may be configured to include the detection system 100 for recognizing the pedestrian based on image data acquired through the surveillance camera 110 installed in the child protection zone and having the constant sensing field of view 110a, acquiring the location information about the pedestrian based on the image data and the pedestrian, and transmitting the location information about the pedestrian to the vehicle 200 traveling in the child protection zone, and the driving assistance device 230 for displaying the location information about the pedestrian to the driver.

FIG. 4 is a view illustrating a situation where pedestrians are present in a child protection zone blind spot.

Referring to FIG. 4, the detection system 100 is facing the vehicle 200 traveling toward the surveillance camera 110. In this case, the reference direction of the detection system 100 is the driving direction of the vehicle 200, which is upward based on the plane of FIG. 4. However, the reference direction is not limited thereto, and there may be no separate preset reference direction. This is because, as described above, the processor 231 may check the reference direction that is opposite to the direction in which the surveillance camera 110 faces based on the metadata in the image data.

In FIG. 4, there are two pedestrians in the sensing field of view 110a of the surveillance camera 110, and therefore the processor 121 or the processor 231 may recognize the two pedestrians from the image data. In this case, in order to determine the location information about the two pedestrians, the processor 121 or the processor 231 horizontally flips the image acquired from the image data. Next, the processor 121 or the processor 231 determines location information about the two pedestrians as left when a location of the two pedestrians is on the left based on an exact center of the horizontally flipped image and the location information about the two pedestrians as right when the location of the two pedestrians is on the right.

Since the communication range of V2X may be wider than the sensing field of view 110a of the surveillance camera 110, the driving information that has been periodically broadcast from a point of time the vehicle 200 enters the child protection zone may be information before the two pedestrians are recognized.

In either case, the processor 121 of the detection system 100 may identify the vehicle 200 by checking whether there is received driving information. The processor 121 or the processor 231 determines whether the driving direction about the vehicle 200 matches the reference direction (preset or in the image data) based on the driving information.

In FIG. 4, the processor 121 or the processor 231 determines that the driving direction of the vehicle 200 and the reference direction (preset or in the image data) match. Accordingly, the processor 121 or the processor 231 may confirm or horizontally flip the location information about the two pedestrians.

The vehicle 200 has a blind spot due to a vehicle in front of the two pedestrians on the opposite side, and the two pedestrians are located in the blind spot. At this point of time, the driving assistance device 230 may receive the location information about the two pedestrians or the image data of the two pedestrians and provide the location information about the two pedestrians to the display device 210 and/or the audio device 220 to warn the driver that there are two pedestrians on the left.

According to one embodiment, when the processor 121 of the detection system 100 may acquire the location information about the pedestrians based on the image data, other two vehicles except the vehicle 200 in FIG. 4 may also be considered as vehicles when the two vehicles are also capable of V2X communication. In this case, the detection system 100 may not transmit the location information about the two pedestrians to a vehicle that has already passed the two pedestrians.

More specifically, the processor 121 may recognize vehicles, pedestrians, lane lines, and the like based on the image data acquired by the surveillance camera 110. Here, a portion of the rear of the vehicle that has already passed the two pedestrians is obscured by the two pedestrians, or a portion of the rear of the vehicle and the two pedestrians generate an overlapping region. The processor 121 may recognize from the image that a portion of the rear of the vehicle that has already passed the two pedestrians is obscured by or overlaps with the two pedestrians. Therefore, even when driving information is received from the vehicle that has already passed the two pedestrians, the processor 121 may not transmit the location information about the two pedestrians to the vehicle depending on the image recognition result.

In contrast, the detection system 100 may transmit the location information about the two pedestrians to a vehicle traveling toward the two pedestrians. Since the vehicle traveling toward the two pedestrians has broadcasted driving information about itself to the detection system 100, the detection system 100 may identify the corresponding vehicle as currently traveling toward the two pedestrians based on the driving information about the corresponding vehicle. The processor 121 may identify through image recognition that two pedestrians are leaving the sidewalk and crossing the lane, and accordingly, the processor 121 may determine that there are two pedestrians in front of the corresponding vehicle based on the location information about the two pedestrians and the driving information about the corresponding vehicle. Therefore, in this case, the processor 121 may determine the location information about the two pedestrians as front of the corresponding vehicle, rather than as left or right and transmit the determined location information to the corresponding vehicle.

According to one embodiment, the surveillance camera 110 may include a first camera and a second camera, each having a field of view in opposite directions. That is, the first camera may have a field of view facing a vehicle approaching the surveillance camera 110 as in a general case, and the second camera may have a field of view facing a 180-degree opposite direction.

In this way, the surveillance camera 110 may include the first camera for monitoring an approaching vehicle 200 from detection target lanes and the second camera facing the vehicle 200 moving away from the surveillance camera 110. In this case, a reference direction of the first camera and a reference direction of the second camera are opposite directions based on a first image acquired through image data of the first camera and a second image acquired through image data of the second camera.

Therefore, when the surveillance camera 110 includes the first camera and the second camera each having a field of view in opposite directions, the processor 121 or the processor 231 may horizontally flip the first image of the first camera to determine location information about the pedestrians based on the horizontally flipped image, but may not horizontally flip the second image of the second camera to determine the location information about the pedestrians based on the intact second image.

In this way, when the surveillance camera 110 includes two cameras (the first camera and the second camera) each having a field of view in opposite directions, the surveillance camera 110 may have twice the sensing field of view compared to a surveillance camera including a single camera having a general sensing field of view, so that a wider blind spot may be handled.

As described above, when the surveillance camera 110 includes the first camera and the second camera each having a field of view in opposite directions, the processor 121 or the processor 231 determines the location information about the pedestrians in the first image in the horizontally flipped state, and determines the location information about the pedestrians in the second image in the original state. However, since the reference direction (preset or in the image data) is always the same regardless of the first camera and the second camera, even when the surveillance camera 110 includes the first camera and the second camera each having a field of view in opposite directions, the processor 121 or the processor 231 may be set to determine whether the driving direction of the vehicle 200 matches the reference direction (preset or in the image data) in the same manner.

FIG. 5 illustrates a situation in which location information about a pedestrian is displayed on a head-up display 210 of the vehicle 200 in the child protection zone blind spot warning system 1 according to one embodiment.

Referring to FIG. 5 in conjunction with FIG. 4, here, the display device 210 may be the head-up display 210. The head-up display 210 displays on the right that a zone in which the vehicle 200 is traveling is a child protection zone, a current speed limit is 30 km/h, and a current speed of the vehicle 200 is 27 km/h.

When the vehicle 200 receives the location information about the two pedestrians, as in the head-up display 210 illustrated at the top of FIG. 5, the pedestrian warning region 211 may be formed on the left under the control of the driving assistance device 230, and a warning icon indicating caution may be displayed at the exact center of the pedestrian warning region 211. As the head-up display 210 receives the location information (left side) about the two pedestrians from the processor 231, the head-up display 210 intuitively displays the two recognized pedestrians as being present on the left based on the driving direction of the vehicle 200.

Although not illustrated, like the head-up display 210 of FIG. 5, the audio device 220 may also provide the warning to the driver by converting the location information about the two pedestrians into voice such as “There are currently two pedestrians on the left. Be careful!.”

The head-up display 210 illustrated in the middle of FIG. 5 represents a case where location information indicating that a pedestrian is on the right of the vehicle 200 is provided.

The head-up display 210 at the bottom of FIG. 5 has a screen showing a case where pedestrians are recognized as being on both sides.

The processor 231 may recognize at least one pedestrian present on each of the left and right.

When it is detected that there are pedestrians on both sides, the processor 231 may skip a process of acquiring location information about the plurality of recognized pedestrians. The child protection zone blind spot warning system 1 or the driving assistance device 230 according to one embodiment of the present disclosure is designed to notify the driver that a pedestrian is on the left or right when the pedestrian is present on the left and/or right. However, when there are pedestrians on both sides, since pedestrians already are present on both sides, the detection system 100 or the processor 231 of the driving assistance device 230 may provide the same information to the driver by simply providing simple information indicating that pedestrians are present on both sides without the need to separately determine location information about a plurality of pedestrians.

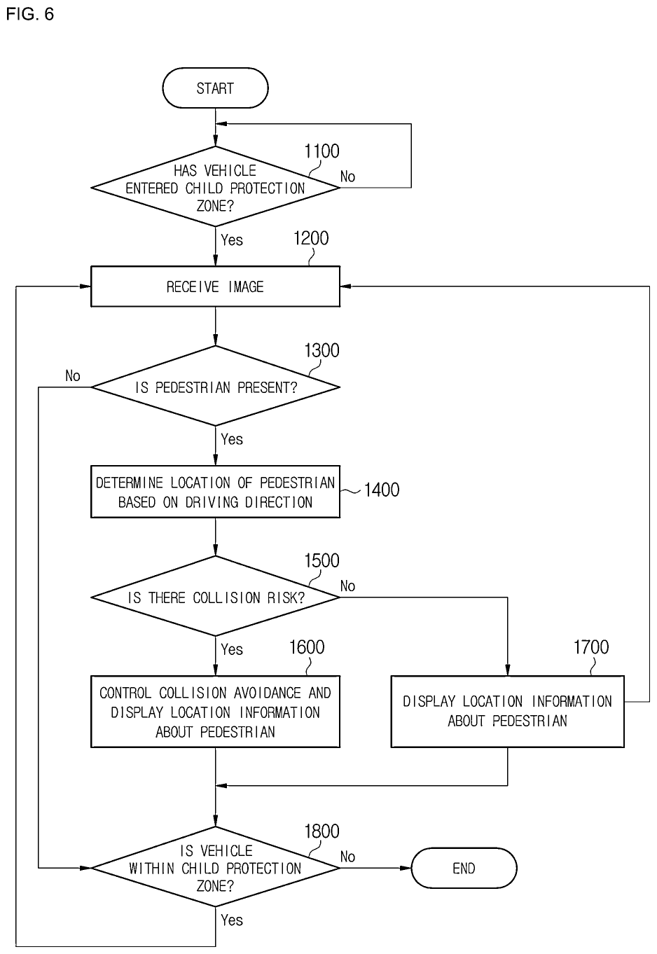

FIG. 6 is a flowchart showing a driving assistance method according to one embodiment.

Referring to FIG. 6, the driving assistance method according to one embodiment may include an operation of determining whether a vehicle 200 has entered a child protection zone (1100), an operation of receiving image data from a surveillance camera 110 having a constant sensing field of view 110a in the child protection zone when it is determined that the vehicle has entered the child protection zone (1200), an operation of recognizing a pedestrian based on the image data (1300), an operation of determining location information about the pedestrian as either left or right based on a driving direction when the pedestrian is recognized (1400), an operation of determining a possibility of collision based on a distance between the vehicle 200 and the pedestrian and a driving speed of the vehicle 200 (1500), and an operation of controlling one of a driving device 280, a braking device 260, or a steering device 270 of the vehicle 200 based on the determination result (1600).

The driving assistance method may further include an operation of displaying the location information about the pedestrian when there is no possibility of collision.

In the operation of controlling one of the driving device 280, the braking device 260, or the steering device 270 of the vehicle based on the determination result (1600), the display device 210 may be controlled to display a collision risk warning when the possibility of collision is equal to or higher than a first risk level and less than a second risk level.

In the operation of controlling one of the driving device 280, the braking device 260, or the steering device 270 of the vehicle 200 based on the determination result (1600), the braking device 260 may be controlled to perform emergency braking when the possibility of collision is equal to or higher than the preset second risk level. In addition, at the same time, the display device 210 may be controlled to display the collision risk warning.

After the operation 1600 or 1700, the driving assistance method may further include an operation of determining whether the vehicle 200 is present within the child protection zone (1800). When the vehicle 200 is present within the child protection zone, the driving assistance method may return to the operation 1200.

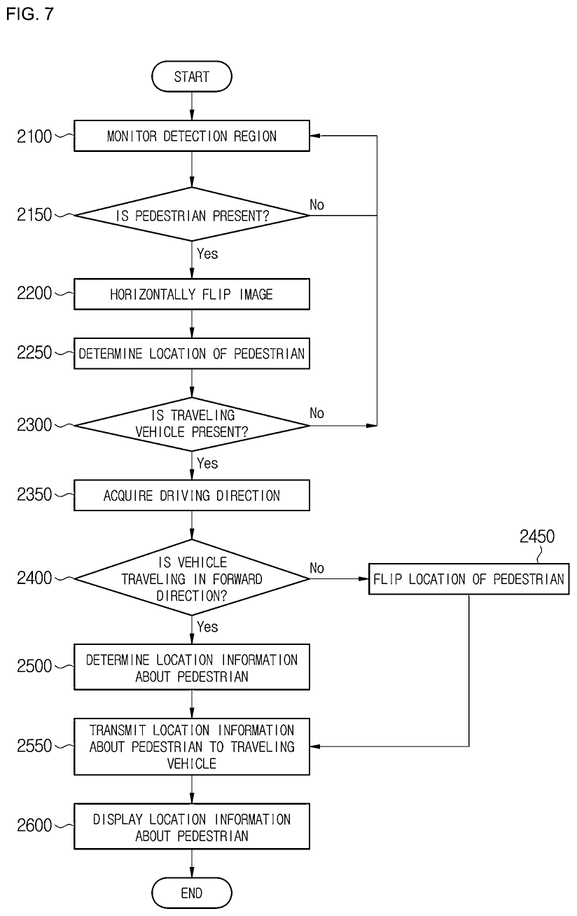

FIG. 7 is a flowchart showing a driving assistance method according to another embodiment.

Referring to FIG. 7, the driving assistance method according to another embodiment may include an operation of monitoring a detection region within a child protection zone (2100), an operation of determining whether a pedestrian is present in the detection region (2150), an operation of horizontally flipping an image when the pedestrian is present (2200), an operation of determining location information about the pedestrian (2250), an operation of determining whether a vehicle 200 is present in the child protection zone (2300), an operation of acquiring a driving direction of the vehicle 200 when the vehicle 200 is present (2350), an operation of determining whether the vehicle is a vehicle traveling in a forward direction based on the driving direction of the vehicle 200 (2400), an operation of confirming the location information about the pedestrian when the vehicle is the vehicle traveling in the forward direction (2500), an operation of transmitting the location information about the pedestrian to the vehicle 200 (2550), and an operation of displaying the location information about the pedestrian to a driver (2600). In the operation of determining whether the vehicle is a vehicle traveling in a forward direction based on the driving direction of the vehicle 200 (2400), the driving assistance method may further include an operation of horizontally flipping the location information about the pedestrian when the vehicle is not the vehicle traveling in the forward direction (2450).

Here, the location information about the pedestrian may indicate either left or right based on the driving direction of the vehicle 200.

In the operation of monitoring a detection region within a child protection zone (2100), a child protection zone blind spot warning system 1 acquires image data captured by a surveillance camera 110.

In the operation of determining whether a pedestrian is present in the detection region (2150), the child protection zone blind spot warning system 1 recognizes the pedestrian based on the image data.

In the operation of determining whether a vehicle 200 is present in the child protection zone (2300), the child protection zone blind spot warning system 1 determines whether the vehicle 200 is present based on whether driving information is received.

In the operation of displaying the location information about the pedestrian to a driver (2600), the child protection zone blind spot warning system 1 displays the location information about the pedestrian on a display device 210.

In the operation of displaying the location information about the pedestrian to a driver (2600), the child protection zone blind spot warning system 1 may represent the location information about the pedestrian using an audio device 220.

In the operation of determining whether a pedestrian is present in the detection region (2150), the child protection zone blind spot warning system 1 may acquire information on the type of the pedestrian by classifying the type of the pedestrian when the pedestrian is recognized, and further transmit the information on the type of the pedestrian to the vehicle 200.

According to one embodiment, when at least one pedestrian is recognized as being present on each of both sides in the operation of determining whether a pedestrian is present in the detection region (2150), the operation of determining whether the vehicle is a vehicle traveling in a forward direction based on the driving direction of the vehicle 200 (2400), the operation of confirming the location information about the pedestrian when the vehicle is the vehicle traveling in the forward direction (2500), and the operation of horizontally flipping the location information about the pedestrian when the vehicle is not the vehicle traveling in the forward direction (2450) may be omitted.

The child protection zone blind spot warning system 1 or the driving assistance device 230 according to one embodiment of the present disclosure is designed to notify the driver that a pedestrian is on the left or right when the pedestrian is present on the left and/or right. However, when there is at least one pedestrian on both sides, since pedestrians already are present on both sides, the child protection zone blind spot warning system 1 or the driving assistance device 230 may provide the same information to the driver by simply providing simple information indicating that pedestrians are present on both sides without the need to separately determine location information about a plurality of pedestrians.

In the operation of determining whether the vehicle 200 is a vehicle 200 traveling in the forward direction based on the driving direction (2400), the child protection zone blind spot warning system 1 determines whether the driving direction matches a preset reference direction and determines the vehicle 200 as the forward vehicle 200 when the driving direction and the reference direction match.

Meanwhile, when the driving direction does not match the reference direction, the child protection zone blind spot warning system 1 determines that the vehicle 200 is a reverse vehicle 200.

According to one aspect of the present disclosure, a driving assistance device and a driving assistance method capable of displaying a location of a pedestrian present in a blind spot in a child protection zone as left or right based on a vehicle together with a warning can be provided.

Thereby, the driving assistance device and driving assistance method can encourage safe driving by making it easy for a driver of a vehicle traveling in the child protection zone to find out the presence and location of a pedestrian, and can provide convenience so that the driver can drive with an easy mind when a pedestrian is not present.

The above description is merely illustrative of the technical idea of the present disclosure, and those of ordinary skill in the art to which the present disclosure pertains will be able to make various modifications and variations without departing from the essential characteristics of the present disclosure. Accordingly, the embodiments disclosed in the present disclosure are not intended to limit the technical idea of the present disclosure, but to explain the technical idea, and the scope of the technical idea of the present disclosure is not limited by these embodiments. The scope of protection of the present disclosure should be interpreted by the accompanying claims, and all technical ideas within the scope equivalent thereto should be construed as being included in the scope of the present disclosure.

What is claimed is:

1. A driving assistance device of a vehicle, comprising:
a transceiver configured to receive image data from a surveillance camera having a constant sensing field of view within a child protection zone; and
a processor configured to recognize a pedestrian based on the image data received from the surveillance camera, generate location information indicating that the pedestrian is located at left or right of the vehicle based on a driving direction of the vehicle when the pedestrian is recognized in the image data received from the surveillance camera, and control a display device of the vehicle to display the location information of the pedestrian indicating whether the pedestrian is located at the left or right of the vehicle.

2. The driving assistance device according to claim 1, wherein the processor is configured to determine whether the pedestrian is located at the left or right of the vehicle based on metadata of the image data received from the surveillance camera and driving information of the vehicle.

3. The driving assistance device according to claim 2, wherein the processor is configured to:
horizontally flip an image acquired from the image data received from the surveillance camera, generate the location information of the pedestrian indicating that the pedestrian is located at the left of the vehicle when the pedestrian is located at left in the horizontally flipped image, and generate the location information of the pedestrian indicating that the pedestrian is located at the right of the vehicle when the pedestrian is located at right in the horizontally flipped image; and
confirm the location information of the pedestrian when a direction in which the surveillance camera faces matches the driving direction of the vehicle.

4. The driving assistance device according to claim 2, wherein the processor is configured to horizontally flip the location information of the pedestrian when a direction in which the surveillance camera faces is opposite to the driving direction of the vehicle, and control the display device to display the horizontally flipped location information of the pedestrian.

5. The driving assistance device according to claim 2, wherein the location information of the pedestrian further includes a distance between the vehicle and the pedestrian.

6. The driving assistance device according to claim 5, wherein the processor is configured to determine a possibility of collision based on the distance between the vehicle and the pedestrian and a driving speed of the vehicle, and control the vehicle based on the possibility of the collision.

7. The driving assistance device according to claim 6, wherein the processor is configured to control the display device to display a collision risk warning when the possibility of the collision is equal to or higher than a first risk level and less than a second risk level.

8. The driving assistance device according to claim 7, wherein the processor is configured to control to perform emergency braking when the possibility of the collision is equal to or higher than the second risk level.

9. The driving assistance device according to claim 1, wherein the processor is configured to control to output an audio representing the location information of the pedestrian.

10. The driving assistance device according to claim 1, wherein the processor is configured to classify a type of the pedestrian recognized in the image data received from the surveillance camera and control the display device to display information related to the type of the pedestrian.

11. The driving assistance device according to claim 10, wherein the processor is configured to control to output an audio representing the information related to the type of the pedestrian recognized in the image data received from the surveillance camera.

12. The driving assistance device according to claim 1, wherein the image data is received from the surveillance camera through vehicle-to-everything (V2X) communication.

13. The driving assistance device according to claim 1, wherein the display device comprises at least one of a cluster display, a center fascia display, or a head-up display (HUD).

14. A method performed by a driving assistance device of a vehicle configured to communicate with a surveillance camera, the driving assistance method comprising:
determining whether a vehicle enters or is located in a child protection zone;
receiving image data from the surveillance camera having a sensing field of view within the child protection zone when it is determined that the vehicle enters or is located in the child protection zone;
recognizing a pedestrian based on the image data received from the surveillance camera;
generating location information of the pedestrian indicating whether the pedestrian is located at left or right of the vehicle based on a driving direction of the vehicle when the pedestrian is recognized in the image data received from the surveillance camera; and
outputting the location information of the pedestrian indicating whether the pedestrian is located at the left or right of the vehicle.

15. The method according to claim 14, wherein the generating of the location information of the pedestrian whether the pedestrian is located at the left or right of the vehicle comprises horizontally flipping an image acquired from the image data received from the surveillance camera, generate the location information of the pedestrian indicating that the pedestrian is located at the left of the vehicle when the pedestrian is located at left in the horizontally flipped image, generate the location information of the pedestrian indicating that the pedestrian is located at the right of the vehicle when the pedestrian is located at right in the horizontally flipped image, and confirming the location information of the pedestrian when a direction in which the surveillance camera faces matches the driving direction of the vehicle.

16. The method according to claim 15, wherein the generating of the location information of the pedestrian indicating whether the pedestrian is located at the left or right of the vehicle comprises horizontally flipping the location information of the pedestrian when the direction in which the surveillance camera faces is opposite to the driving direction of the vehicle, and controlling a display device to display the horizontally flipped location information of the pedestrian.

17. The method according to claim 14, further comprising: after the generating of the location information of the pedestrian indicating whether the pedestrian is located at the left or right of the vehicle,
determining a possibility of collision based on a distance between the vehicle and the pedestrian and a driving speed of the vehicle; and
controlling the vehicle based on the possibility of the collision.

18. The method according to claim 17, wherein the controlling of the vehicle based on the possibility of the collision comprises controlling a display device to display a collision risk warning when the possibility of collision is equal to or higher than a first risk level and less than a second risk level.

19. The method according to claim 18, wherein the controlling of the vehicle based on the possibility of the collision comprises controlling to perform emergency braking when the possibility of collision is equal to or higher than the second risk level.

20. A child protection zone blind spot warning system comprising:
a detection system configured to recognize a pedestrian based on image data received from a surveillance camera having a sensing field of view within a child protection zone, acquire location information of the pedestrian based on the image data received from the surveillance camera, and transmit the location information of the pedestrian to a vehicle entering into or travelling in the child protection zone through V2X communication; and
a driving assistance device comprised in the vehicle entering into or travelling in the child protection zone and configured to receive the location information of the pedestrian through the V2X communication and display the location information of the pedestrian,
wherein the location information of the pedestrian indicating whether the pedestrian is located at left or right is generated based on a driving direction of the vehicle.
